(19) United States
(12) Patent Application Publication
(10) Pub. No.: US 2020/0103923 A1
(43) Pub. Date: Apr. 2, 2020

(54) OBSTACLE DETECTION METHOD AND APPARATUS, AND UNMANNED AERIAL VEHICLE

(71) Applicant: Autel Robotics Co.,Ltd., Shenzhen (CN)

(72) Inventor: Guangyao Zhu, Shenzhen (CN)

(21) Appl. No.: 16/691,305

(22) Filed: Nov. 21, 2019

Related U.S. Application Data
(63) Continuation of application No. PCT/CN2018/081067, filed on Mar. 29, 2018.

(30) Foreign Application Priority Data
May 22, 2017 (CN) 201710364166.5

(51) Int. Cl. G05D 1/10; G01S 17/933; B64C 39/02; B64D 47/00

(52) U.S. Cl. CPC G05D 1/106; G01S 17/933; B64C 2201/12; B64D 47/00; B64C 2201/027; B64C 39/024

(57) ABSTRACT

This application discloses an obstacle detection apparatus and method, and an unmanned aerial vehicle (UAV). The obstacle detection apparatus includes a distance measurement and calculation unit, a receiving tube connected to the distance measurement and calculation unit, at least two emitting tubes connected to the distance measurement and calculation unit, and a measurement controller connected to the at least two emitting tubes. The measurement controller is configured to control the at least two emitting tubes, and the receiving tube is configured to receive an optical signal, the optical signal received by the receiving tube being formed after an optical signal emitted by the emitting tube is reflected by an obstacle. The distance measurement and calculation unit is configured to: obtain a phase of the emitted optical signal and a phase of the received optical signal, and calculate a distance between the obstacle and the obstacle detection apparatus based on a phase difference between the phase of the emitted optical signal and the phase of the received optical signal. In this way, a range of obstacle measurement can be effectively expanded.

This application is a continuation of International Patent Application No. PCT/CN2018/081067 filed on Mar. 29, 2018 which claims priority to Chinese Patent Application No. 2017103641665 filed on May 22, 2017, which is incorporated herein by reference in its entirety.

### BACKGROUND

### Technical Field

The present invention relates to the field of unmanned aerial vehicles (UAV), and in particular, to an obstacle detection method and apparatus, and a UAV.

### Related Art

As functions of an unmanned aerial vehicle (UAV) gradually become intelligent, the UAV can autonomously avoid an obstacle. The UAV may use a laser radar to perform obstacle ranging, and then perform functions such as obstacle avoidance based on a measured distance.

The UAV avoids the obstacle using the laser radar based on a time of flight (ToF) ranging method. In the ToF ranging method, a distance between an object and the UAV is mainly measured using a round-trip ToF of an optical signal between an emitting tube and a receiving tube. Currently, a measurement range in this implementation is narrow, resulting in a poor obstacle avoidance effect of the UAV.

### SUMMARY

In view of the above, embodiments of this application provide an obstacle detection apparatus and method, an unmanned aerial vehicle (UAV), and an intelligent device, to expand an obstacle measurement range.

According to a first aspect, an embodiment of this application provides an obstacle detection apparatus, including:

a distance measurement and calculation unit, a receiving tube connected to the distance measurement and calculation unit, at least two emitting tubes connected to the distance measurement and calculation unit, and a measurement controller connected to the at least two emitting tubes, where

the measurement controller is configured to control the at least two emitting tubes, and the receiving tube is configured to receive an optical signal, the optical signal received by the receiving tube being formed after an optical signal emitted by the emitting tube is reflected by an obstacle; and

the distance measurement and calculation unit is configured to: obtain a phase of the emitted optical signal and a phase of the received optical signal, and calculate a distance between the obstacle and the obstacle detection apparatus based on a phase difference between the phase of the emitted optical signal and the phase of the received optical signal.

Optionally, the obstacle detection apparatus may further include:

at least two control switches,

one end of each of the at least two control switches being connected to one emitting tube, and the other end being connected to the measurement controller, where

the measurement controller is configured to control a control switch in the at least two control switches to be closed.

Further, the measurement controller is configured to control control switches in the at least two control switches to be sequentially closed and other control switches to be opened.

Alternatively, the obstacle detection apparatus may further include:

a multi-position selector switch, where

an input end of the multi-position selector switch is connected to the measurement controller;

each output end of the multi-position selector switch is connected to one of the at least two emitting tubes; and

the measurement controller is configured to control an output end connected to the input end of the multi-position selector switch.

Alternatively, the obstacle detection apparatus controls, using a control instruction, an emitting tube corresponding to the control instruction in the at least two emitting tubes to emit an optical signal.

Further, for different emitting tubes, the measurement controller sends control instructions of different types or different names or control instructions carrying different identifiers.

Optionally, the measurement controller is configured to control emitting tubes in the at least two emitting tubes to sequentially emit optical signals.

Optionally, the measurement controller is configured to control emitting tubes in the at least two emitting tubes to simultaneously emit optical signals.

Optionally, the measurement controller is connected to the distance measurement and calculation unit; and

the measurement controller is further configured to: obtain a distance value calculated by the distance measurement and calculation unit, and determine a distance from the obstacle based on the distance value.

Optionally, the measurement controller is further configured to determine a direction of the obstacle relative to the obstacle detection apparatus based on orientation information of an emitting tube related to the distance value.

Optionally, when there is one receiving tube, a viewing angle of the receiving tube is greater than a sum of emission angles of all of the at least two emitting tubes.

Optionally, there are at least two receiving tubes.

Optionally, a quantity of distance measurement and calculation units is the same as a quantity of receiving tubes, each distance measurement unit being connected to one receiving tube, and each receiving tube being connected to one distance measurement unit.

Optionally, each receiving tube corresponds to one emitting tube,

an optical signal received by each receiving tube being formed after an optical signal emitted by an emitting tube corresponding to each receiving tube is reflected by the obstacle.

Optionally, the measurement controller is further configured to: obtain distance values calculated by at least two distance measurement and calculation units, and determine the distance from the obstacle based on the distance values calculated by the at least two distance measurement and calculation units.

Optionally, the measurement controller is further configured to: obtain a distance value calculated by each distance measurement and calculation unit, and use an average of distance values calculated by all distance measurement units as the distance from the obstacle.

Optionally, emission regions of all emitting tubes are different.

Optionally, the emitting tube includes at least one of the following: an infrared emitting tube, a laser emitting tube, and a visible light emitting tube.

Optionally, the control switch includes at least one of the following: a transistor, a field effect transistor, an analog switch, and a relay.

According to a second aspect, an embodiment of this invention provides an obstacle detection method, including:

controlling, by, a measurement controller, an emitting tube in at least two emitting tubes to emit an optical signal;

receiving, by a receiving tube, an optical signal, the optical signal received by the receiving tube being formed after the emitted optical signal is reflected by an obstacle; and

obtaining, by a distance measurement and calculation unit, a phase of the emitted optical signal and a phase of the received optical signal, and calculating a value of a distance between an obstacle detection apparatus and the obstacle based on a phase difference between the phase of the emitted optical signal and the phase of the received optical signal.

Optionally, the method further includes:

determining, by the measurement controller, a direction of the obstacle relative to the obstacle detection apparatus based on orientation information of an emitting tube related to the distance value.

Optionally, the measurement controller obtains distance values calculated by at least two distance measurement and calculation units, and determines the distance between the obstacle detection apparatus and the obstacle based on the distance values calculated by the at least two distance measurement and calculation units.

Optionally, the controlling, by a measurement controller, an emitting tube in at least two emitting tubes to emit an optical signal includes:

controlling, by the measurement controller, emitting tubes in the at least two emitting tubes to sequentially emit optical signals; or

controlling, by the measurement controller, emitting tubes in the at least two emitting tubes to simultaneously emit optical signals.

According to a third aspect, an embodiment of this application provides a UAV, including:

a flight controller; and

an obstacle detection apparatus connected to the flight controller, where

the obstacle detection apparatus includes any of the foregoing obstacle detection apparatuses;

the obstacle detection apparatus is configured to send distance information to the flight controller; and

the flight controller is configured to process the distance information.

According to a fourth aspect, an embodiment of this application provides an intelligent device, including:

a master controller; and

an obstacle detection apparatus connected to the master controller, where

the obstacle detection apparatus includes any of the foregoing obstacle detection apparatuses;

the obstacle detection apparatus is configured to send determined distance information to the master controller; and

the master controller is configured to process the distance information.

According to the embodiments of this application, the obstacle detection apparatus includes the distance measurement and calculation unit, the receiving tube connected to the distance measurement and calculation unit, the at least two emitting tubes connected to the distance measurement and calculation unit, and the measurement controller connected to the at least two emitting tubes. The measurement controller is configured to control the at least two emitting tubes, and the receiving tube is configured to receive the optical signal, the optical signal received by the receiving tube being formed after the optical signal emitted by the emitting tube is reflected by the obstacle. The distance measurement and calculation unit is configured to: obtain the phase of the emitted optical signal and the phase of the received optical signal, and calculate the distance between the obstacle and the obstacle detection apparatus based on the phase difference between the phase of the emitted optical signal and the phase of the received optical signal. The obstacle detection apparatus can expand an obstacle detection range.

### BRIEF DESCRIPTION OF THE DRAWINGS

FIG. 1 is a schematic structural diagram of an unmanned aerial vehicle (UAV) according to an embodiment of this application.

FIG. 2 is a schematic structural diagram of an obstacle detection apparatus according to an embodiment of this application.

FIG. 3 is a principle diagram of a module of a UAV during an obstacle avoidance flight at any angle according to an embodiment of this application.

FIG. 4 is an orientation setting diagram of a measurement range of an emitting tube according to an embodiment of this application.

FIG. 5 is a first example diagram of an obstacle avoidance flight of a UAV according to an embodiment of this application.

FIG. 6 is a second example diagram of an obstacle avoidance flight of a UAV according to an embodiment of this application.

FIG. 7 is a schematic structural diagram of an intelligent device according to an embodiment of this application.

FIG. 8 is a schematic flowchart of an obstacle detection method according to an embodiment of this application.

### DETAILED DESCRIPTION

To make the objectives, technical solutions, and advantages of the embodiments of the present invention clearer and more comprehensible, the following farther describes the embodiments of the present invention in detail with reference to the accompanying drawings. The exemplary embodiments of the present invention and the description thereof are used for explaining the present invention, but are not intended to limit the present invention.

It should be noted that the “obstacle detection apparatus” in the embodiments of the present invention may be applied to an unmanned aerial vehicle (UAV); or may be applied to an intelligent device such as a robot; or may be applied to other scenarios in which an obstacle is detected and a distance from obstacle is detected.

The UAV and the intelligent device such as the robot in the embodiments of the present invention may be equipped with the obstacle detection apparatus. According to the obstacle detection apparatus, a detection range of the obstacle can be expanded, and precession of calculating the distance from the obstacle can be ensured.

### EMBODIMENT 1

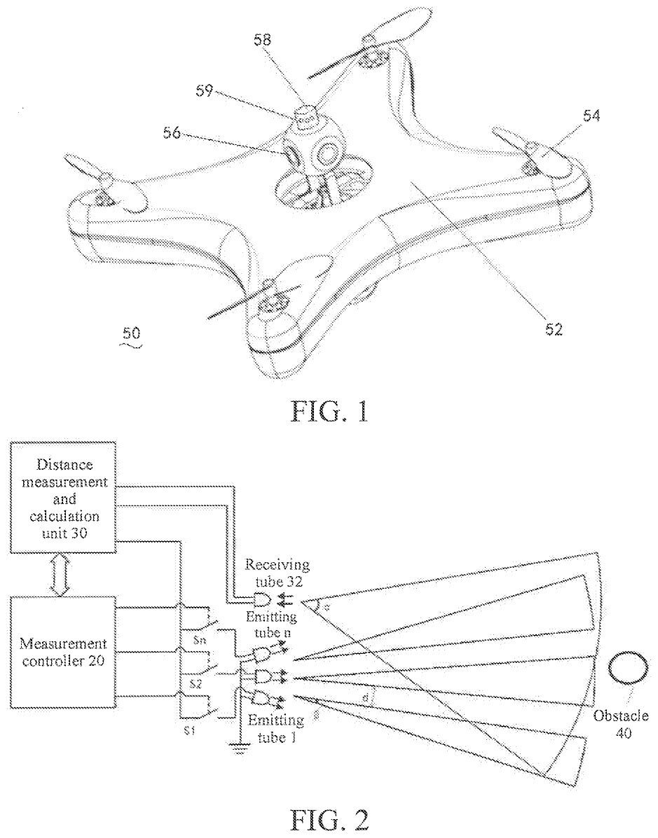

Referring to FIG. 2, FIG. 2 is a schematic structural diagram of an obstacle detection apparatus.

The Obstacle detection apparatus is configured to detect an obstacle and a distance from the obstacle, and includes a distance measurement and calculation unit 30, a receiving tube 32, at least two emitting tubes 1 to n, and a measurement controller 20. The distance measurement and calculation unit 30 is separately connected to the receiving tube 32 and the at least two emitting tubes 1 to n, and the measurement controller 20 is separately connected to the at least two emitting tubes 1 to n.

In an implementation, there may be one or more distance measurement and calculation units, and a quantity of receiving tubes is the same as a quantity of distance measurement and calculation units. One distance measurement and calculation unit 30 is correspondingly connected to one receiving tube 32. In other words, each distance measurement and calculation unit is connected to one receiving tube, and each receiving tube is connected to one measurement and calculation unit.

For each receiving tube 32, at least two emitting tubes are correspondingly disposed, that is, an emitting tube 1 to an emitting tube n, where n is a positive integer and n≥2. That a receiving tube may receive an optical signal that is formed after an optical signal emitted by an emitting tube is reflected by an obstacle may be understood as that the receiving tube corresponds to the emitting tube.

An output end of the measurement controller 20 is separately connected to input ends of emitting tubes (the emitting tube 1 to the emitting tube n) to output control signals to the emitting tubes. Alternatively, an output end of the measurement controller 20 may be connected to an input end of an emitting tube using a component such as a switch.

The measurement controller 20 may control an emitting tube in the at least two emitting tubes (the emitting tube 1 to the emitting tube n) to emit an optical signal.

In particular, the measurement controller 20 may control emitting tubes in the at least two emitting tubes to sequentially emit optical signals, or control emitting tubes in the at least two emitting tubes to simultaneously emit optical signals.

That the emitting tubes sequentially emit the optical signals means that each time the measurement controller 20 controls one emitting tube to emit an optical signal. The measurement controller 20 may control a same emitting tube or different emitting tubes during two adjacent times of controlling, which is not limited herein. In an implementation, the measurement controller 20 may control emitting tubes in the at least two emitting tubes to alternately emit optical signals. Further, the measurement controller 20 may determine a control sequence of emitting tubes based on mounting positions of the emitting tubes or in another manner, and then control, based on the control sequence, the emitting tubes to sequentially emit optical signals. In this way, an obstacle detection range can be expanded in a period of time.

That emitting tubes simultaneously emit optical signals means that each time the measurement controller 20 controls at least two emitting tubes to simultaneously emit optical signals. In this case, it may be understood that the optical signals emitted by the at least two emitting tubes are the same, and that the optical signals are the same may mean that phases of the optical signals are the same. Therefore, in this way, an obstacle detection range can be expanded at one moment.

If a receiving tube may receive the optical signal within a receiving range of the receiving tube, it indicates that there is an obstacle within a detection range of the obstacle detection apparatus. A viewing angle of the receiving tube may be used to represent the receiving range of the receiving tube.

If the obstacle detection apparatus includes one receiving tube, the receiving tube corresponds to all emitting tubes in the obstacle detection apparatus. A viewing angle of the receiving tube is greater than or equal to a sum of emission angles of all the emitting tubes.

If the obstacle detection apparatus includes at least two receiving tubes, the obstacle detection apparatus correspondingly includes a same quantity of distance measurement and calculation units as the receiving tubes. In this case, each receiving tube may correspond to one or more emitting tubes. A viewing angle of each receiving tube is greater than or equal to a sum of emission angles of all of the corresponding emitting tubes.

The distance measurement and calculation unit may obtain a phase of an optical signal received by a receiving tube connected to the distance measurement and calculation unit, and may obtain a phase of an optical signal emitted by an emitting tube corresponding to the receiving tube. If only one of emitting tubes corresponding to the receiving tube emits an optical signal, the distance measurement and calculation unit obtains a phase of the optical signal emitted by the emitting tube. If two or more of the emitting tubes corresponding to the receiving tube simultaneously emit optical signals, because the optical signals emitted by the emitting tubes are the same, the distance measurement and calculation unit may obtain a phase of the optical signal emitted by any one of the two or more emitting tubes.

Further, the distance measurement and calculation unit may calculate a value of a distance from the obstacle based on a phase difference between the obtained phase of the received optical signal and the obtained phase of the emitted optical signal.

For example, each of the at least two emitting tubes may be an infrared emitting tube, a laser emitting tube, a visible light emitting tube, or an emitting tube that can emit other optical signals. If each emitting tube is an infrared emitting tube, the foregoing optical signal may be understood as an infrared optical signal. Correspondingly, a type of a receiving tube is the same as a type of a corresponding emitting tube. That is, when the type of the emitting tube is an infrared emitting tube, the type of the receiving tube is an infrared receiving tube; when the type of the emitting tube is a laser emitting tube, the type of the receiving tube is a laser receiving tube. If the obstacle detection apparatus includes at least two receiving tubes, types of the receiving tubes may be the same or different, which is not limited herein.

The emitting tube may be implemented as a light-emitting diode or other light source components, which is not limited herein.

For example, emission regions of all of the at least two emitting tubes in the obstacle detection apparatus are different. The emission region is a region that can be covered by an optical signal emitted by the emitting tube. The emission region of the emitting tube may be determined based on an emission angle of the emitting tube and/or an emission direction of the emitting tube. The emission angle of the emitting tube is used to represent an emission range of the emitting tube. That is, if the emission angle is large, the emission range is large, or if the emission angle is small, the emission range is small. The emission direction of the emitting tube may be determined based on a mounting direction of the emitting tube and/or an emission direction of the optical signal. In this embodiment of this application, the mounting direction of the emitting tube is adjustable or fixed, which is not limited herein.

Therefore, obstacles in different regions can be detected using emitting tubes in different emission regions, thereby expanding an obstacle detection region.

In an embodiment, an emission angle (β) of each emitting tube is less than or equal to 3 degrees to ensure measurement effectiveness. If the emission angle (β) of the emitting tube is smaller, a resolution of obstacle avoidance measurement is higher.

In addition, a distance between adjacent emitting tubes may vary based on different measurement precision requirements. If a precision requirement is high, the distance between the adjacent emitting tubes is smaller. If a precision requirement is low, the distance between the adjacent emitting tubes is larger. Alternatively, an included angle between adjacent emitting tubes may vary based on different measurement precision requirements, which is not limited herein.

For example, if the obstacle detection apparatus includes one receiving tube, a viewing angle of the receiving tube may be greater than or equal to a sum of emission angles of the foregoing emitting tubes, so that the receiving tube can receive optical signals emitted by the emitting tubes.

Optionally, the measurement controller 20 may further include at least two control switches. As shown in FIG. 2, the control switches are S1 to Sn. The measurement controller 20 may be connected to at least two emitting tubes (the emitting tube 1 to the emitting tube n) using the control switches S1 to Sn. In particular, one end of each control switch is connected to the measurement controller 20, and the other end is connected to an input end of one emitting tube. For example, as shown in FIG. 2, one end of the control switch S1 may be connected to an output end of the measurement controller 20, and the other end of the control switch S1 is connected to an input end of the emitting tube 1.

The control switch may be implemented by a single-open single-control switch. That is, one control switch includes only one input end and one output end. When the switch is closed, the input end of the control switch is connected to the output end. In particular, the control switch may include at least one of the following: a transistor, a field effect transistor, an analog switch, and a relay.

Alternatively, the measurement controller 20 may further include a multi-position selector switch. In particular, an input end of the multi-position selector switch may be connected to an output end of the measurement controller 20, and each output end of the multi-position selector switch may be connected to one emitting tube. Further, the measurement controller 20 may control the output end connected to the input end of the multi-position selector switch. When the input end of the multi-position selector switch is connected to one output end, it may be understood that one position switch in the multi-position selector switch is closed.

The measurement controller 20 may control one or more output ends of the multi-position selector switch to be connected to the input end of the multi-position selector switch. That is, the measurement controller may control one or more position switches in the multi-position selector switch to be closed. If the measurement controller 20 controls one output end of the multi-position selector switch to be connected to the input end of the multi-position selector switch, the measurement controller 20 controls an emitting tube connected to the output end to emit an optical signal. If the measurement controller 20 controls a plurality of output ends of the multi-position selector switch to be connected to the input end of the multi-position selector switch, the measurement controller 20 controls emitting tubes respectively connected to the plurality of output ends to simultaneously emit optical signals.

Alternatively, the output end of the measurement controller 20 may be directly connected to at least two emitting tubes. In particular, one output end of the measurement controller 20 may be connected to one or more of the at least two emitting tubes, which is not limited herein. The measurement controller may control, using a control instruction, an emitting tube corresponding to the control instruction in the at least two emitting tubes to emit an optical signal.

If one output end of the measurement controller 20 is connected to one emitting tube, the measurement controller may control to output a control instruction at an output end, so as to control an emitting tube connected to the output end to emit an optical signal. Control instructions output by all output ends may be the same or may be different, which is not limited herein.

If one output end of the measurement controller 20 is connected to a plurality of emitting tubes, the measurement controller may output a control instruction through the output end. The control instruction may correspond to one or more of the plurality of emitting tubes.

If the control instruction corresponds to one of the plurality of emitting tubes, it may be understood that the measurement controller 20 controls different emitting tubes by sending different control instructions. The different control instructions may be control instructions of different types or different names, or control instructions including different bytes or carrying different identifiers, or the like. When each of a plurality of emitting tubes receives one control instruction, each emitting tube may determine, based on information such as a type or a name of the control instruction, or a byte included in or an identifier carried in the control instruction, whether the emitting tube corresponds to the control instruction.

Optionally, the measurement controller 20 may select two or more of the emitting tube 1 to the emitting tube n based on a preset rule, and control the selected emitting tubes to simultaneously emit optical signals, which is not limited herein. For example, based on information such as orientation information or an emission region of each emitting tube, the two or more of the emitting tube 1 to the emitting tube n are selected to emit optical signals.

Optionally, the measurement controller 20 may control, based on a preset order of emitting tubes, the emitting tubes to sequentially emit optical signals. For example, the preset order of the emitting tubes may be based on emission regions or orientation information of the emitting tubes. Further, the measurement controller 20 may first select two or more of the emitting tube 1 to the emitting tube n, and then control the selected two or more emitting tubes to sequentially emit optical signals. For example, if the measurement controller 20 selects the emitting tube 1 to an emitting tube m based on emission regions of the emitting tubes, where m is a positive integer and m≤n, the measurement controller 20 may control the emitting tube 1 to emit an optical signal for the first time, and control an emitting tube 2 to emit an optical signal for the second time until the emitting tube in is controlled to emit an optical signal for the m^{th} time; or the measurement controller 20 may sequentially control, based on emission angles of the emitting tubes in descending order of the emission angles, the emitting tubes to emit optical signals.

Optionally, after the obstacle detection apparatus is activated, the measurement controller 20 continuously emits optical signals through the emitting tubes, and continuously repeats the determining until the obstacle detection apparatus is deactivated.

Optionally, the measurement controller 20 may be connected to the distance measurement and calculation unit 30, and the measurement controller 20 may obtain a distance value calculated by the distance measurement and calculation unit 30.

Further, if the obstacle detection apparatus includes at least two distance measurement and calculation units, the obstacle detection apparatus may obtain distance values calculated by one or more of the at least two distance measurement and calculation units.

In particular, in an implementation, if the distance measurement and calculation unit calculates a distance value, the distance value is sent to the measurement controller 20. In another implementation, the measurement controller 20 selects one or more of the at least two distance measurement and calculation units, and obtains distance values calculated by the one or more distance measurement and calculation units.

Optionally, the measurement controller may further process one or more obtained distance values. For example, the one or more distance values are stored in a storage medium or are sent to other apparatuses.

Further, if the measurement controller obtains a plurality of distance values at a time, the distance from the obstacle may be determined based on the plurality of distance values.

In an implementation, the measurement controller may obtain a distance value calculated by each of the at least two distance measurement and calculation units, and use an average of distance values calculated by all distance measurement and calculation units as the distance from the obstacle.

Certainly, the measurement controller may determine the distance from the obstacle based on the plurality of distance values in other implementations, which is not limited herein.

Further, after obtaining the distance value, the measurement controller 20 may determine an emitting tube related to the distance value. That is, after the measurement controller 20 controls an emitting tube to emit an optical signal, if the distance value is obtained, it may be determined that the emitting tube is related to the distance value.

The measurement controller 20 may obtain orientation information of the emitting tube, the orientation information of the emitting tube including at least one piece of information such as a mounting direction, a mounting position, or an emission region of the emitting tube, and determine a direction of the obstacle relative to the obstacle detection apparatus based on the obtained orientation information of the emitting tube. The direction may be expressed by an angle, which is not limited herein.

For the case in which emitting tubes sequentially emit optical signals, the following gives an example for description.

As shown in FIG. 2, the emitting tube I to the emitting tube n are connected to the measurement controller 20 through the control switches S1 to Sn. That is, the measurement controller 20 is connected to one emitting tube through one control switch, and the measurement controller 20 controls one control switch to be closed and other control switches to be opened, to control an emitting tube connected to the closed control switch to emit an optical signal.

During measurement, the measurement controller 20 may initialize the distance measurement and calculation unit 30 and initialize an on/off state of each of the control switches S1 to Sn.

Then the measurement controller 20 controls the control switch S1 to be closed to perform measurement for the first time, and the measurement controller 20 controls the emitting tube 1 to emit an optical signal. If there is no obstacle, the optical signal emitted by the emitting tube 1 is not reflected, and the receiving tube 32 does not receive a reflected optical signal. If there is an obstacle 40, the optical signal emitted by the emitting tube 1 is reflected by the obstacle 40, and the receiving tube 32 may receive the reflected optical signal.

The distance measurement and calculation unit 30 connected to the receiving tube 32 measures a value of a distance between the obstacle detection apparatus and the obstacle 40 according to the TOF principle, and may send the distance value to the measurement controller. In addition, the measurement controller 20 may obtain orientation information of the emitting tube 1, and may determine a direction of the obstacle relative to the obstacle detection apparatus based on the orientation information. In this case, the first time of measurement is completed.

The measurement controller 20 opens the control switch S1 and closes the control switch S2 to perform measurement for the second time. When each of the emitting tube 1 to the emitting tube n is measured, a plurality of emitting tubes correspondingly connected to the receiving tube 32 completes one round of obstacle detection.

In an implementation, the obstacle detection apparatus may send distance information of the obstacle to other apparatuses, such as a flight controller in a UAV, so that the other apparatuses can further process the distance information of the obstacle output by the obstacle detection apparatus. The distance information of the obstacle may include information such as a value of a distance from the obstacle and/or a direction of the obstacle relative to the obstacle detection apparatus. Optionally, after the obstacle detection apparatus is activated, the measurement controller 20 continuously controls emitting tubes to emit optical signals until the obstacle detection apparatus is deactivated.

In this technical solution, the distance from the obstacle and the relative direction of the obstacle can be calculated, and obstacle detection precision is improved.

In this technical solution, a measurement field of view of the distance measurement and calculation unit 30 can be flexibly expanded from common 3 degrees to any angle such as 60 degrees, 90 degrees, 180 degrees, or 360 degrees.

Optionally, the obstacle detection apparatus can accurately obtain orientation information of the obstacle. In order to obtain an orientation of the obstacle, mounting angles and mounting positions are separately preset for the plurality of emitting tube 1 to n. In this embodiment of this application, a mounting angle and/or a mounting position of an emitting tube are/is adjustable or fixed, which is not limited herein.

Referring to FIG. 4, in this embodiment, emitting tubes D1 to D7 are disposed on an obstacle avoidance plane defined by an X axis and a Y axis. A mounting angle of the emitting tube D7 is 30 degrees, a mounting angle of the emitting tube D6 is 45 degrees, a mounting angle of the emitting tube DS is 60 degrees, a mounting angle of the emitting tube D4 is 90 degrees, a mounting angle of the emitting tube D3 is 105 degrees, a mounting angle of the emitting tube D2 is 135 degrees, and a mounting angle of the emitting tube D1 is 150 degrees. The measurement controller 20 controls the emitting tubes D1 to D7 to alternately emit optical signals, and may determine a direction to the obstacle based on orientation information of each emitting tube, such as a mounting angle or an emission direction. For example, when it is determined that there is an obstacle at five meters in front of the emitting tube D6, it may be learned that an orientation of the obstacle at the distance of five meters is a mounting angle of 45 degrees to the right front based on orientation information of the emitting tube D6 and the mounting angle 45 degrees.

For example, the distance measurement and calculation unit may include at least the following subunits:

a phase obtaining subunit configured to obtain a phase of an optical signal emitted by an emitting tube or obtain a phase of an optical signal received by a receiving tube; and

a calculation subunit configured to calculate a value of a distance from an obstacle based on the phase that is of the optical signal and that is obtained by the phase obtaining subunit.

Optionally, the distance measurement and calculation unit may further include an interface, and the distance measurement and calculation unit may send, through the interface, the calculated distance value to the measurement controller or to other apparatuses connected to the obstacle detection apparatus.

The subunits included in the distance measurement and calculation unit may be implemented by software, hardware, or a combination of both. Further, the distance measurement and calculation unit may be integrated into an optical signal processing chip. The optical signal processing chip may calculate the distance from the Obstacle based on a difference between the phases of the optical signals. In specific implementation, reference may be made to the Intersil's ISL29501 chip. It may be understood that other optical signal processing chips that can implement the foregoing function also fall within the protection scope of this application.

For example, the measurement controller may be implemented by a central processing unit (CPU), a microprocessor unit (MCU), or a single-chip microcomputer.

Optionally, the obstacle detection apparatus may further include a storage medium. The storage medium may be a random storage medium, a magnetic disk, an optical disc, or the like. A stored resource may include one or more of a driver, an operating system, an application program, and data, and a storage manner may be transitory storage or persistent storage. The data may include a control instruction, a correspondence table, or the distance value the orientation information, and the like in the foregoing embodiment.

The driver is used to manage and control hardware of the obstacle detection apparatus, and communication between the hardware and the operating system or the application program is implemented using the driver.

The operating system is used to manage and control the hardware of the obstacle detection apparatus and the application program to implement data calculation and processing by the measurement controller and the distance measurement and calculation unit. In this embodiment of this application.

The application program is a computer program that performs at least one specific function based on the operating system, and may include at least one function module. Each function module may include a series of program instructions to implement one function of the obstacle detection apparatus.

The storage medium may communicate with the measurement controller and/or the distance measurement and calculation unit through a bus connection or the like.

Optionally, the distance detection apparatus may further include a power source. The power supply is configured to supply a voltage to each component of the distance detection apparatus to ensure proper working of each component.

Optionally, the distance detection apparatus may further include an interface. The interface includes at least one of the following: a wired or wireless network interface, a serial-to-parallel conversion interface, an input/output interface, a USB interface, and the like, and the interface is used for communicating with an external device.

Certainly, the distance detection apparatus may further include other components, which are not limited herein.

### EMBODIMENT 2

Referring to FIG. 1, this application also relates to a UAV 50 using the obstacle detection apparatus.

The UAV 50 includes a flight controller (not shown in FIG. 1) and an obstacle detection apparatus 58, and may further include a fuselage 52, four rotors 54, a camera assembly 56, and the like. The obstacle detection apparatus 58 includes at least two emitting tubes 59.

In FIG. 1, a position of the obstacle detection apparatus 58 on the UAV 50 is merely an example. The obstacle detection apparatus 58 may be mounted within the fuselage 52 of the UAV 50 or outside the fuselage 52; or the obstacle detection apparatus 58 may be mounted at a front end, a rear end, a side end, a top end, a bottom end, or the like of the UAV 50. Likewise, a mounting position of the emitting tube 59 on the obstacle detection apparatus 58 is also merely an example. In this embodiment of this application, the mounting position of the obstacle detection apparatus 58 on the UAV 50 and the mounting position of the emitting tube 59 on the obstacle detection apparatus 58 are not limited.

In addition, a quantity of obstacle detection apparatuses 58 mounted on the UAV 50 is not limited.

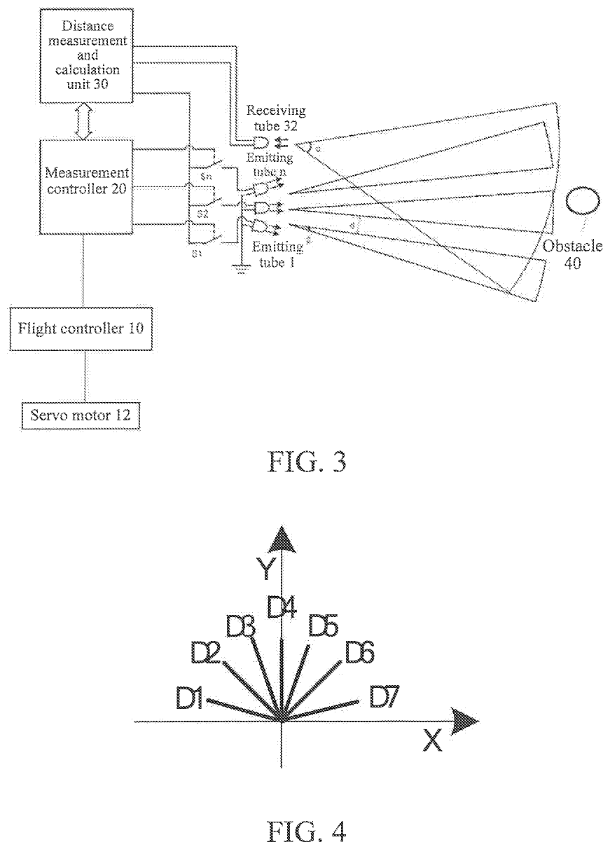

Referring to FIG. 3, the obstacle detection apparatus 58 is configured to detect an obstacle and a distance from the obstacle. For a structure of the obstacle detection apparatus 58, refer to the foregoing embodiment. Details are not described herein again.

Referring to a diagram of a module of a UAV during an obstacle avoidance flight in FIG. 3, the UAV 50 further includes: a flight controller 10 mounted in the fuselage, the flight controller being understood as a flight controller or a flight control system herein; and a propulsion system connected to the flight controller 10, the propulsion system including a servo motor 12. Four servo motors 12 may be disposed to drive the four rotors 54 to drive the UAV 50 to fly.

In particular, the obstacle detection apparatus 58 may detect the obstacle and send distance information of the obstacle to the flight controller 10, such as a value of the distance from the obstacle and a direction of the obstacle relative to the obstacle detection apparatus. The flight controller 10 further processes the distance information. For example, the flight controller 10 transmits the distance information to a ground station corresponding to the UAV 50 using a data transmission system; or the flight controller 10 stores the distance information in a storage medium configured by the UAV 50; or the flight controller 10 further determines a flight path based on the distance information to implement an obstacle avoidance function of the UAV; or the flight controller 10 controls the UAV 50 to perform a hovering action or a tracking action based on the distance information. Herein, the processing of the distance information by the flight controller 10 is not limited in this embodiment of this application.

The obstacle detection apparatus 58 detects an obstacle within a specified range, generates a detection result of the obstacle, and sends the detection result to the flight controller 10. The flight controller 10 determines a flight path based on the detection result of the distance and an orientation to perform an obstacle avoidance flight.

In a first implementation of the obstacle detection apparatus 58, one distance measurement and calculation unit and a measurement controller connected to the distance measurement and calculation unit are specifically included, the measurement controller being connected to a plurality of emitting tubes. The measurement controller alternately controls each of the emitting tubes, generates a detection result of the distance from the obstacle and/or a relative direction of the obstacle by combining the distance measurement and calculation unit and a receiving tube, and sends the detection result to the flight controller 10. The flight controller performs an obstacle avoidance flight based on the detection result.

In this embodiment, an obstacle avoidance range specified by the UAV is a region, and the single distance measurement and calculation unit is connected to one receiving tube. The plurality of emitting tubes connected to the measurement controller cooperates with the distance measurement and calculation unit and the receiving tube to complete obstacle detection under the control of the measurement controller. A viewing angle (α) of the receiving tube is greater than a sum of emission angles (β) of all emitting tubes to ensure that the receiving tube can cover an entire emission range.

In a second implementation of the obstacle detection apparatus 58, the obstacle avoidance range specified by the UAV includes at least two regions. The obstacle detection apparatus 58 specifically includes at least two distance measurement and calculation units corresponding to the obstacle avoidance regions and a measurement controller connected to the at least two distance measurement and calculation units. Receiving tubes are separately disposed for the at least two distance measurement and calculation units, and the measurement controller is connected to a plurality of emitting tubes. The measurement controller alternately controls each of the emitting tubes to generate a detection result by combining a corresponding distance measurement and calculation unit and a corresponding receiving tube, and the flight controller performs an obstacle avoidance flight based on the detection result.

In this embodiment, each distance measurement and calculation unit is connected to one receiving tube. The plurality of emitting tubes connected to the measurement controller are grouped based on the to-be-monitored specified obstacle avoidance range, and each group of emitting tubes cooperate with a corresponding distance measurement and calculation unit and a corresponding receiving tube to complete measurement of the distance from the obstacle and the orientation of the obstacle under the control of the measurement controller. A viewing angle (α) of each receiving tube is greater than a sum of emission angles (β) of the corresponding group of emitting tubes to ensure that the receiving tube can cover an entire emission range.

Likewise, as shown in FIG. 4, in order that the measurement controller can simultaneously obtain the orientation of the obstacle, mounting angles and mounting positions are preset for the plurality of emitting tubes. For example, an emitting tube D1 to an emitting tube D4 are connected to a receiving tube and form a first detection group with a distance measurement and calculation unit connected to the receiving tube; and an emitting tube D5 to an emitting tube D7 are connected to another receiving tube and form a second detection group with a distance measurement and calculation unit connected to the receiving tube. Mounting angles of the emitting tube D1 to the emitting tube D7 are respectively 157.5 degrees, 135 degrees, 112.5 degrees, 90 degrees, 67.5 degrees, 45 degrees, and 22.5 degrees. Corresponding position orientations of the emitting tube D1 to the emitting tube D7 are respectively a 1st left-front position, a 2nd left-front position, a 3rd left-front position, a front-right position, a 1st right-front position, a 2nd right-front position, and a 3rd right-front position. In order to ensure precision of obstacle detection, an emission angle (β) of each emitting tube is less than or equal to 3 degrees. In order to obtain a beat obstacle avoidance effect using a minimum quantity of emitting tubes, a distance d between adjacent emitting tubes is specified. For example, the specified distance d is 3 millimeters.

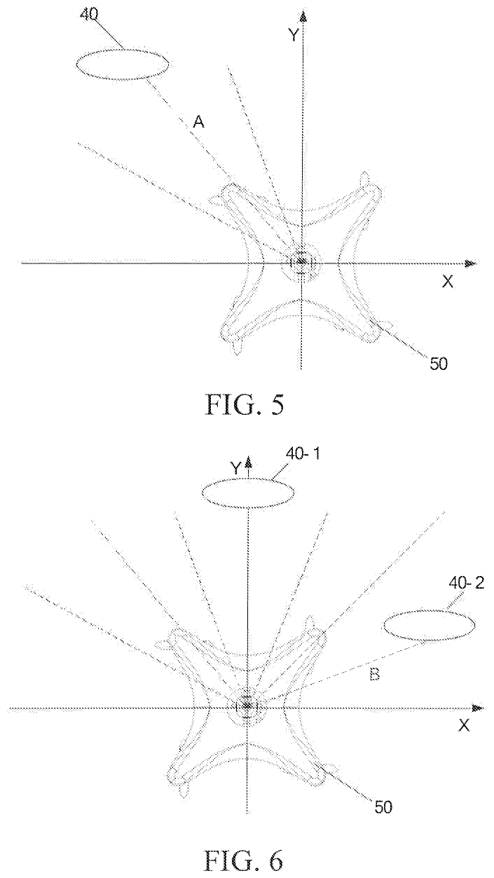

FIG. 5 is a first example diagram of an obstacle avoidance flight of a UAV according to an embodiment of the present invention. Referring to an orientation setting of an emitting tube shown in FIG. 4, the UAV flies on a flight plane defined by X and Y axes. In this implementation, the obstacle detection apparatus 58 of the UAV detects that there is an obstacle 40 at a distance A from the UAV after controlling the emitting tube D2 to emit an optical signal, and the measurement controller obtains orientation information of the emitting tube D2, such as a mounting angle 135 degrees. Herein, the mounting angle may be understood as an emission direction of the emitting tube D2 or a mounting direction of the emitting tube D2, and the mounting angle is used to indicate a direction of a detector relative to the obstacle detection apparatus. The measurement controller combines the distance A and the mounting angle 135 degrees into two-dimensional data and sends the two-dimensional data to the flight controller 10. The flight controller 10 adjusts a rotational speed of the servo motor or other apparatuses in the propulsion system to avoid slowing down or bypassing if the obstacle 40 is hit, such as an obstacle avoidance flight in a lower right direction.

FIG. 6 is a second example diagram of an obstacle avoidance flight of a UAV according to an embodiment of the present invention. Referring to an orientation setting of an emitting tube shown in FIG. 4, the UAV flies on a flight plane defined by X and Y axes. In this implementation, the obstacle detection apparatus of the UAV detects that there is an obstacle 40-1 at a distance B from the UAV after controlling the emitting tube D7 to emit an optical signal, and the measurement controller obtains orientation information of the emitting tube D7, such as a mounting angle 30 degrees. The measurement controller combines the distance B and the mounting angle 30 degrees into two-dimensional data and sends the two-dimensional data to the flight controller 10. The flight controller 10 adjusts the servo motor or other apparatuses in the propulsion system to avoid slowing down or bypassing if the obstacle 40-1 is hit, such as an obstacle avoidance flight in a lower left direction.

### EMBODIMENT 3

This embodiment of this application further relates to a flight control system including a flight controller, the flight controller being connected to an obstacle detection apparatus for detecting an obstacle within a specified range. For a structure of the obstacle detection apparatus, refer to the description of the foregoing embodiment. The obstacle detection apparatus may output a detection result to the flight controller, and the flight controller performs an obstacle avoidance flight based on the detection result.

In order to simultaneously obtain an orientation of the obstacle, mounting angles and mounting positions are preset for the plurality of emitting tubes. For example, as shown in FIG. 4, an emitting tube D1 to an emitting tube D4 are connected to a receiving tube and form a first detection group with a distance measurement and calculation unit connected to the receiving tube; and an emitting tube D5 to an emitting tube D7 are connected to another receiving tube and form a second detection group with a distance measurement and calculation unit connected to the receiving tube. Mounting angles of the emitting tube D1 to the emitting tube D7 are respectively 157.5 degrees, 135 degrees, 112.5 degrees, 90 degrees, 67.5 degrees, 45 degrees, and 22.5 degrees. Corresponding position orientations of the emitting tube D1 to the emitting tube D7 are respectively a 1st left-front position, a 2nd left-front position, a 3rd left-front position, a front-right position, a 1st right-front position, a 2nd right-front position, and a 3rd right-front position. The measurement controller or the distance measurement and calculation unit may record and select, based on a calculation result of the distance measurement and calculation unit, an emitting tube that calculates a distance value, for example, the emitting tube 137, to roughly derive an orientation of the obstacle, that is, a 3rd right-front position at 22.5 degrees.

In an implementation, the specified range is one region. The at least one distance measurement and calculation unit is a single distance measurement and calculation unit, and the distance measurement and calculation unit is connected to one receiving tube. The plurality of emitting tubes connected to the measurement controller cooperates with the distance measurement and calculation unit and the receiving tube to complete measurement of the distance from the obstacle and the orientation of the obstacle under the control of the measurement controller. A viewing angle (α) of the receiving tube is greater than a sum of emission angles (β) of all emitting tubes.

In another implementation, the specified range is at least two regions. At least two distance measurement and calculation units are included, each distance measurement and calculation unit being connected to one receiving tube. The plurality of emitting tubes connected to the measurement controller are grouped based on the to-be-monitored specified range, and each group of emitting tubes cooperate with a corresponding distance measurement and calculation unit and a corresponding receiving tube to complete measurement of the distance from the obstacle and the orientation of the obstacle under the control of the measurement controller. A viewing angle (α) of each receiving tube is greater than a sum of emission angles (β) of the corresponding group of emitting tubes.

In order to ensure precision of obstacle detection, an emission angle (β) of each emitting tube is less than or equal to 3 degrees, and a distance between emission angles of adjacent emitting tubes is specified.

According to the obstacle detection apparatus, the UAV, and the flight control system provided in this embodiment, the receiving tube and the plurality of emitting tubes in coverage of the viewing angle of the receiving tube implement obstacle measurement within the specified range or an obstacle avoidance response under the control of the measurement controller. In addition, quantity and positions of emitting tubes connected to the measurement controller are adjusted, so that a range of obstacle measurement of the UAV can be effectively expanded. Meanwhile, the measurement controller may obtain two-dimensional distance and orientation information of an obstacle target, so that the UAV, the robot, and the like can implement reliable automatic obstacle avoidance during obstacle avoidance route planning.

In the present invention, a quantity of emitting tubes within a range of a viewing angle of a same receiving tube is increased or decreased to cooperate with the corresponding distance measurement and calculation unit and the measurement controller, thereby ensuring to obtain an accurate distance from an obstacle within the specified viewing range and increasing an obstacle avoidance viewing angle of an electronic device such as a UAV or a robot. According to this technical solution, a viewing angle of a single chip can be flexibly expanded from common 3 degrees to any angle such as 60 degrees, 90 degrees, 180 degrees, or 360 degrees, and orientation information of the obstacle is accurately obtained.

### EMBODIMENT 4

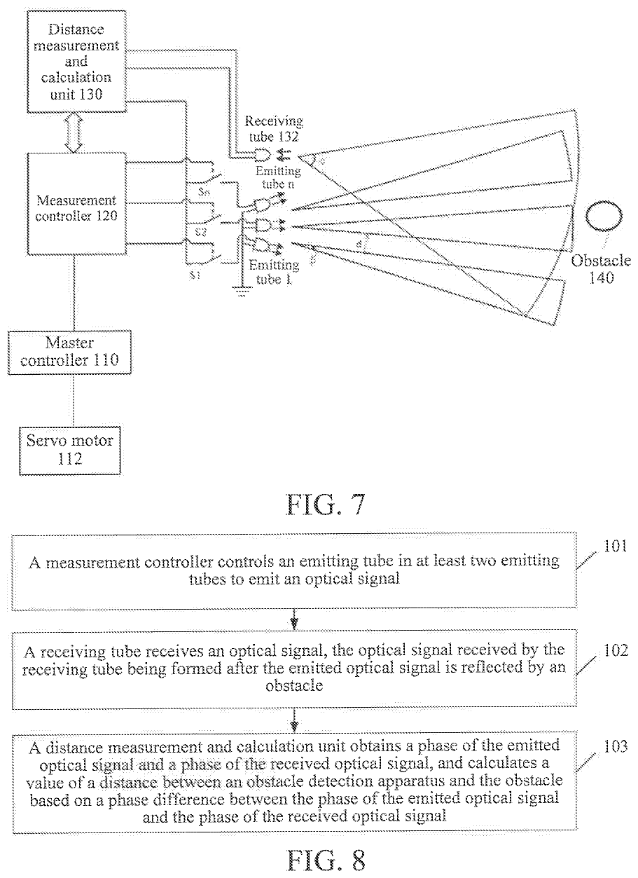

This embodiment of this application further relates to an obstacle detection method, to detect an obstacle within a specified range. For the obstacle detection method, refer to a structure of the obstacle detection apparatus in the foregoing embodiment or structures of other obstacle detection apparatuses, which is not limited herein. Referring to FIG. 8, the method may include the following steps.

Step 101: A measurement controller controls an emitting tube in at least two emitting tubes to emit an optical signal.

Step 102: A receiving tube receives an optical signal, the optical signal received by the receiving tube being formed after the emitted optical signal is reflected by an obstacle.

Step 103: A distance measurement and calculation unit obtains a phase of the emitted optical signal and a phase of the received optical signal, and calculates a value of a distance between an obstacle detection apparatus and the obstacle based on a phase difference between the phase of the emitted optical signal and the phase of the received optical signal.

Optionally, the method may further include: the measurement controller determines a direction of the obstacle relative to the obstacle detection apparatus based on orientation information of an emitting tube related to the distance value.

Optionally, the method may further include: the measurement controller obtains distance values calculated by at least two distance measurement and calculation units, and determines the distance between the obstacle detection apparatus and the obstacle based on the distance values calculated by the at least two distance measurement and calculation units.

Optionally, that a measurement controller controls an emitting tube in at least two emitting tubes to emit an optical signal includes:

the measurement controller controls emitting tubes in the at least two emitting tubes to sequentially emit optical signals; or

the measurement controller controls emitting tubes in the at least two emitting tubes to simultaneously emit optical signals.

For implementation of each step in the foregoing method, refer to the description of the foregoing embodiment. Details are not described herein again.

The method may further include any method in the foregoing embodiment, which is not limited herein.

For example, mounting angles and mounting positions are preset for the plurality of emitting tubes. A mounting angle and/or a mounting position of an emitting tube may be fixed or adjustable, which is not limited herein.

For example, as shown in FIG. 4, an emitting tube Di to an emitting tube D4 are connected to a receiving tube and form a first detection group with a distance measurement and calculation unit connected to the receiving tube; and an emitting tube D5 to an emitting tube D7 are connected to another receiving tube and form a second detection group with a distance measurement and calculation unit connected to the receiving tube. Mounting angles of the emitting tube D1 to the emitting tube D7 are respectively 157.5 degrees, 135 degrees, 112.5 degrees, 90 degrees, 67.5 degrees, 45 degrees, and 22.5 degrees. Corresponding position orientations of the emitting tube D1 to the emitting tube D7 are respectively a 1st left-front position, a 2nd left-front position, a 3rd left-front position, a front-right position, a 1st right-front position, a 2nd right-front position, and a 3rd right-front position. The measurement controller records and selects an emitting tube that calculates a distance value, and stores the distance value, may determine a position and an orientation of the obstacle by detecting a position and an orientation of the emitting tube, for example, the emitting tube D1, to roughly derive the orientation of the obstacle, that is, a 1st left-front position at 157.5 degrees.

### EMBODIMENT 5

Referring to FIG. 7, FIG. 7 shows an application of the obstacle detection apparatus in another robot product. The robot includes a master controller connected to an obstacle detection apparatus for detecting an obstacle within a specified range. For a structure of the obstacle detection apparatus, refer to the foregoing embodiment. The obstacle detection apparatus may output a detection result, and the master controller performs obstacle avoidance walking or moving based on the detection result.

In order to simultaneously obtain an orientation of the obstacle, mounting angles and mounting positions are preset for the plurality of emitting tubes.

In this embodiment, the specified range is one region. The at least one distance measurement and calculation unit is a single distance measurement and calculation unit, and the distance measurement and calculation unit is connected to one receiving tube. The plurality of emitting tubes connected to the measurement controller cooperates with the distance measurement and calculation unit and the receiving tube to complete measurement of the distance from the obstacle and the orientation of the obstacle under the control of the measurement controller. A viewing angle (α) of the receiving tube is greater than a sum of emission angles (β) of all emitting tubes to ensure that the receiving tube can cover an entire emission range.

In this embodiment, the specified range is at least two regions. At least two distance measurement and calculation units are included, each distance measurement and calculation unit being connected to one receiving tube. The plurality of emitting tubes connected to the measurement controller are grouped based on the to-be-monitored specified range, and each group of emitting tubes cooperate with a corresponding distance measurement and calculation unit and a corresponding receiving tube to complete measurement of the distance from the obstacle and the orientation of the obstacle under the control of the measurement controller. A viewing angle (α) of each receiving tube is greater than a sum of emission angles (β) of the corresponding group of emitting tubes to ensure that the receiving tube can cover an entire emission range.

According to the obstacle detection apparatus of the robot in this embodiment, a quantity of program control switches and a quantity of emitting tubes are increased or decreased through adjustment, so that a measurement angle of the robot can be effectively expanded.

The obstacle detection apparatus can simultaneously obtain distance and orientation information of an obstacle target and combine the distance and orientation information into two-dimensional information for use by the master controller, thereby facilitating automatic obstacle avoidance and route planning of the robot and the like. The obstacle detection apparatus does not reduce a measurement range, that is, intensity of an emitted light, and information validity of a nearest obstacle while expanding an angle of view. In addition, the obstacle detection apparatus can realize automatic switching of an emitting tube and automatic determination of a target angle. The foregoing descriptions are merely implementations of the present invention, and the protection scope of the present invention is not limited thereto. All equivalent structure or process changes made according to the content of this specification and accompanying drawings in the present invention or by directly or indirectly applying the present invention in other related technical fields shall fall within the protection scope of the present invention.

What is claimed is:

1. An obstacle detection apparatus, comprising:
a distance measurement and calculation unit;
a receiving tube connected to the distance measurement and calculation unit;
at least two emitting tubes connected to the distance measurement and calculation unit; and
a measurement controller connected to the at least two emitting tubes;
wherein the measurement controller is configured to control the at least two emitting tubes, and the receiving tube is configured to receive an optical signal, the optical signal received by the receiving tube being thrilled after an optical signal emitted by the emitting tube is reflected by an obstacle; and
wherein the distance measurement and calculation unit is configured to: obtain a phase of the emitted optical signal and a phase of the received optical signal, and calculate a distance between the obstacle and the obstacle detection apparatus based on a phase difference between the phase of the emitted optical signal and the phase of the received optical signal.

2. The apparatus according to claim 1, further comprising at least two control switches;
one end of each of the at least two control switches being connected to one emitting tube, and the other end being connected to the measurement controller;
wherein the measurement controller is configured to control a control switch in the at least two control switches to be closed.

3. The apparatus according to claim 2, wherein the measurement controller is configured to control control switches in the at least two control switches to be sequentially closed and other control switches to be opened.

4. The apparatus according to claim 1, further comprising a multi-position selector switch;
wherein an input end of the multi-position selector switch is connected to the measurement controller;
wherein each output end of the multi-position selector switch is connected to one of the at least two emitting tubes; and
wherein the measurement controller is configured to control an output end connected to the input end of the multi-position selector switch.

5. The apparatus according to claim 1, wherein the measurement controller is configured to control, using a control instruction, an emitting tube corresponding to the control instruction in the at least two emitting tubes to emit an optical signal.

6. The apparatus according to claim 5, wherein for different emitting tubes, the measurement controller is configured to send control instructions of different types or different names or control instructions carrying different identifiers.

7. The apparatus according to claim 1, wherein the measurement controller is configured to control emitting tubes in the at least two emitting tubes to sequentially emit optical signals.

8. The apparatus according to claim 1, wherein the measurement controller is configured to control emitting tubes in the at least two emitting tubes to simultaneously emit optical signals.

9. The apparatus according to claim 1, wherein the measurement controller is connected to the distance measurement and calculation unit; and
the measurement controller is further configured to:
obtain a distance value calculated by the distance measurement and calculation unit; and
determine a distance from the obstacle based on the distance value.

10. The apparatus according to claim 9, wherein the measurement controller is further configured to determine a direction of the obstacle relative to the obstacle detection apparatus based on orientation information of an emitting tube related to the distance value.

11. The apparatus according to claim 1, wherein the apparatus comprises one receiving tube;
wherein a viewing angle of the receiving tube is greater than or equal to a sum of emission angles of all of the at least two emitting tubes.

12. The apparatus according to claim 1, wherein the apparatus comprises at least two receiving tubes.

13. The apparatus according to claim 12, wherein a quantity of distance measurement and calculation units is the same as a quantity of receiving tubes, each distance measurement unit being connected to one receiving tube, and each receiving tube being connected to one distance measurement unit.

14. The apparatus according to claim 13, wherein each receiving tube corresponds to one emitting tube,
an optical signal received by each receiving tube being formed after an optical signal emitted by an emitting tube corresponding to each receiving tube is reflected by the obstacle.

15. The apparatus according to claim 14, wherein the measurement controller is further configured to: obtain distance values calculated by at least two distance measurement and calculation units, and determine the distance from the obstacle based on the distance values calculated by the at least two distance measurement and calculation units.

16. The apparatus according to claim 15, wherein the measurement controller is further configured to: obtain a distance value calculated by each distance measurement and calculation unit, and use an average of distance values calculated by all distance measurement units as the distance from the obstacle.

17. The apparatus according to claim 1, wherein emission region of each of the emitting tubes is different.

18. The apparatus according to claim 1, wherein the emitting tube comprises at least one of the following:
an infrared emitting tube, a laser emitting tube, and a visible light emitting tube.

19. The apparatus according to claim 2, wherein the control switch comprises at least one of the following:
a transistor, a field effect transistor, an analog switch, and a relay.

20. An unmanned aerial vehicle (UAV), comprising:
a flight controller;
an obstacle detection apparatus connected to the flight controller; and
a propulsion system connected to the flight controller;
wherein the obstacle detection apparatus is the obstacle detection apparatus according to claim 1;
wherein the obstacle detection apparatus is configured to send determined distance information to the flight controller; and
wherein the flight controller is configured to control the propulsion system based on the distance information.
